(19) United States
(12) Patent Application Publication
(10) Pub. No.: US 2026/0208313 A1
(43) Pub. Date: Jul. 23, 2026

(54) METHOD AND DEVICE FOR PRODUCING A MODIFIED SURFACE STRUCTURE ON A TOOTH FLANK

(71) Applicant: REISHAUER AG, Wallisellen (CH)

(72) Inventor: Christoph LEONHARDT, Wallisellen (DE)

(73) Assignee: REISHAUER AG, Wallisellen (CH)

(21) Appl. No.: 19/140,513

(22) PCT Filed: Dec. 12, 2023
(86) PCT No.: PCT/EP2023/085369

§ 371 Date: Jun. 18, 2025

(30) Foreign Application Priority Data
Dec. 19, 2022 (CH) CH001518/2022

(51) Int. Cl. B24B 5/16; B24B 1/04

(52) U.S. Cl. CPC B24B 5/16; B24B 1/04

(57) ABSTRACT

A method and a machine tool for producing a modified surface structure on a tooth flank of a pre-toothed workpiece are disclosed. By generating a relative movement between the grinding worm and the pre-toothed workpiece, a plurality of adjacent contact tracks are created on the tooth flank of the pre-toothed workpiece. To generate a tooth flank waviness, a penetration depth between the grinding worm and the workpiece is deliberately varied along the respective contact track in such a way that the tooth flank waviness of adjacent contact tracks are shifted by a phase offset relative to one another at any given position in a workpiece depth direction, the phase offset being between 90° and 270°, and/or the phase offset relative to the respective adjacent contact tracks varying from contact track to contact track, and/or the phase offset to the adjacent contact tracks varying along one of the respective contact tracks.

### TECHNICAL FIELD

The present invention relates to a method for producing a modified surface structure on a tooth flank of a pre-toothed workpiece. The invention further relates to a machine tool configured to perform such a method.

### PRIOR ART

Especially in the context of electromobility, due to the lack of the dominant background noise of the combustion engine, the topic of NVH (noise-vibration-harshness) is becoming increasingly important, especially in the gear transmission part of a vehicle. The requirements regarding noise excitation behavior are often specified in the form of predefined limit values in a noise frequency spectrum. Whether a workpiece meets these requirements is usually checked on a random basis on an end-of-line (EOL) test bench. If the measured amplitudes of individual noise frequencies exceed the predefined limit value, the corresponding workpiece is rejected.

A typical noise frequency spectrum of a rotating gear has dominant amplitudes at noise frequencies that correspond to the gear mesh frequency (f_{ZE}=gear rotational frequency×number of teeth) and the associated higher harmonics. These dominant noise frequencies generally result from transmission errors that occur as a result of a meshing stiffness that varies along the length of the path of contact. The course of the meshing stiffness as a function of the position along the length of the path of contact repeats periodically with the meshing pitch and leads to the dominant noise frequencies mentioned above. Another cause may be a “generating hole” created during manufacturing, i.e. material that stands back with respect to the desired profile line.

Overall, all transmission errors of a gearing under load can lead to a noise excitation that is perceptible as a disturbing noise. If, for example, a dressing tool has a certain waviness over the profile height, the waviness is transferred to the worm flank and subsequently leads to a profile form deviation on the workpiece.

Constant vibrations in the periphery of the machine tool used to machine the pre-toothed workpiece can also lead to tooth flank ripples on the tooth flank, which can be measured and result in disturbing noise characteristics of the toothing.

Grooves running across the face width of the gearing can also lead to noise excitation.

Overall, any periodic surface structure, particularly in a direction perpendicular to the line of contact of paired spur gears, can lead to excitation of a noise frequency that is dominant in the noise frequency spectrum of the gearing.

There are several approaches to improving the noise excitation behavior of a gearing. Transmission errors resulting from deformation of the gearing under load can be effectively reduced by modifying the tooth flank. A generating hole can be almost completely eliminated through optimized process control.

DE 10 2012 015 846 A1 discloses a generating grinding process in which a workpiece is machined with a grinding worm, whereby a modification, in particular a profile modification or profile waviness and/or a defined periodic flank waviness, is generated on the active surface of the workpiece being machined by means of deliberate generation of wobbling movement caused by an unbalance of the grinding worm and/or an eccentricity of the grinding worm in order to modify or prevent an undesired flank waviness.

A flank waviness on the workpiece resulting from unbalance or eccentricity of a grinding worm always has the order one with regard to the worm rotational frequency, i.e. it is not possible to generate a flank waviness in this way which has a higher order with regard to the worm rotational frequency.

A periodically repeating surface structure tends to lead to excitation in a relatively narrow noise frequency band. A surface structure that is as irregular as possible in turn leads to a very broad noise frequency spectrum that approximates “white” noise, i.e. a noise frequency spectrum with the same amplitude of all noise frequencies. Such a noise frequency spectrum, in which the dominance of individual noise frequencies tends to be reduced, is perceived psychoacoustically as less disturbing and is therefore advantageous. In addition, in the case of excitations with a broad noise frequency spectrum, the entire excitation energy is distributed over a large frequency range, so that the noise amplitude of each individual frequency component tends to be lower than in the case of excitations in a narrow frequency band.

If the workpiece is machined using a generating grinding process with a grinding worm, periodically repeating surface structures can occur on a tooth flank, for example from the dressing of the grinding worm with which the tooth flank is machined: the dressing wheel used for dressing can have differences in grain size and shape as well as a different grain distribution over its circumference due to the technology used, which leads to a dressing pattern on the surface of the dressing wheel. As the dressing wheel generally performs a large number of revolutions during one revolution of the grinding worm, this dressing pattern is periodically mapped onto the grinding worm during dressing in the direction of the worm thread. During the subsequent grinding of the workpiece, periodic fluctuations in the tooth flank surface can occur on the tooth flanks of the workpiece in the form of grooves that extend across the tooth width.

DE 199 05 136 A1 discloses a method in which the rotation angle of the dressing wheel is coupled to the rotation angle of the grinding worm with an adjustable fixed or programmably variable or a stored stochastically changing ratio, wherein the grinding worm is moved along its axis relative to the workpiece during grinding (shift feed), so that each point of the tooth flanks of the toothing of the workpiece corresponds exactly to a point of the flanks of the grinding worm thread.

The above-mentioned grooves can be broken by purposefully choosing of the shift feed. Although this breaks the periodicity of the tooth flank surface structure and thus in principle achieves a more pleasant noise behavior, the structure transferred to the tooth flank is strongly dependent on the stochastic dressing pattern on the surface of the dressing wheel and can therefore only be influenced by the shift feed during grinding of the workpiece.

There is therefore a need for a method that makes it possible to deliberately modify the surface structure of a tooth flank in such a way that a particularly noise-optimized behavior is achieved.

### SUMMARY OF THE INVENTION

In a first aspect, it is an object of the present invention to provide a method for generating a modified surface structure on a tooth flank of a pre-toothed workpiece by generating grinding, which enables optimization of the noise behavior.

This object is achieved by a method according to claim 1. Further embodiments are given in the dependent claims.

A method for producing a modified surface structure on a tooth flank of a pre-toothed workpiece is therefore proposed, comprising:
driving a grinding worm to rotate around a worm axis;
driving the pre-toothed workpiece to rotate about a workpiece axis, wherein the grinding worm and the pre-toothed workpiece are in rolling engagement, and
generating a relative movement between the grinding worm and the pre-toothed workpiece, the relative movement having an axial component parallel to the workpiece axis, such that a plurality of adjacent contact tracks is produced on the tooth flank of the pre-toothed workpiece, the contact tracks extending at a distance from one another with respect to a workpiece face width direction.

According to the invention, a penetration depth between the grinding worm and the pre-toothed workpiece is deliberately varied along the respective contact track to generate a tooth flank waviness with a plurality of wave periods along said contact track such that the resulting tooth flank waviness of adjacent contact tracks at any given position in a workpiece depth direction, i.e. at any predetermined position across the tooth depth or, in other words, along any predetermined flank line of the tooth flank as viewed in the workpiece face width direction, are shifted relative to one another by a phase offset,
wherein the phase offset is between 90° and 270°, and/or
wherein the phase offset to the respective adjacent contact tracks varies from contact track to contact track, and/or
wherein the phase offset to the adjacent contact tracks varies along the respective contact track.

The arbitrary predetermined flank line, with respect to which the phase offset is defined in the present context, corresponds in the case of a cylindrical workpiece to the intersection line between the tooth flank and a virtual cylinder arranged concentrically to the workpiece axis and having an arbitrary predetermined radius, wherein this radius has a value which lies between the value of the root circle radius and the value of the tip circle radius of the toothed workpiece. This intersection line defines a specific position in the workpiece depth direction, i.e. a specific position across the tooth depth. In the case of a conical workpiece, the flank line in question is defined in the present context as the intersection line with a virtual cone arranged concentrically to the workpiece axis.

In some embodiments, the phase offset to the respective adjacent contact tracks varies from contact track to contact track, i.e. this phase offset is not constant from contact track to contact track. In particular, the phase offset between the tooth flank ripples (waviness) of a first pair of adjacent contact tracks may differ from the phase offset between the tooth flank ripples (waviness) of a second pair of adjacent contact tracks at a different position in the workpiece face width direction.

In some embodiments, alternatively or additionally, the phase offset to the respective adjacent contact tracks varies along the respective contact track. In particular, the tooth flank waviness (ripples) of adjacent contact tracks may have different tooth flank waviness wavelengths, whereby the phase offset between said adjacent contact tracks varies in the direction of said contact tracks. Alternatively or additionally, the tooth flank waviness of the respective contact track may have a tooth flank waviness wavelength which varies along the respective contact track. This can result in a phase offset along the respective contact track that varies with respect to the adjacent contact tracks, provided that the tooth flank waviness wavelengths of the adjacent contact tracks do not vary “synchronously”.

Varying the phase offset to the respective adjacent contact tracks from contact track to contact track or along the respective contact track prevents wave crests and wave troughs occurring along a contact track from forming straight wavefronts (lines of equal waviness phase position) in conjunction with wave crests and wave troughs of the adjacent contact tracks. A surface structure with non-rectilinear wavefronts is advantageous with regard to the resulting noise behavior.

In some embodiments, the phase offset of a contact track to the respective adjacent contact tracks is between 90° and 270°. The phase offset of between 90° and 270° prevents wave crests and wave troughs occurring along the contact track from forming continuous wavefronts in conjunction with wave crests and wave troughs of the adjacent contact tracks. Instead, a broken surface structure is created, which is particularly advantageous in terms of the resulting noise behavior.

With a tooth flank waviness having a fixed periodicity, for example, a chessboard-like surface structure can be generated with a phase offset of 180° to the respective next contact track. Such a structure may offer advantages in terms of noise behavior, especially when superimposed with uncontrolled, in particular stochastically occurring, deviations in penetration depth.

Whether the tooth flank waviness of adjacent contact tracks are shifted by a phase offset relative to each other or not may depend on the variation frequency with which the penetration depth is varied. During machining, the adjacent contact tracks on the tooth flank are generated with a certain generation frequency. If both the variation frequency and the generation frequency are constant and the variation frequency is an integer multiple of the generation frequency, there is no phase offset from contact track to contact track along any flank line on the tooth flank. However, a phase offset can occur if the variation frequency is in a non-integer ratio and/or non-constant ratio to the generation frequency.

Preferably, the grinding worm is moved continuously along a shift direction parallel to the worm axis. As a result, the relative movement between the grinding worm and the pre-toothed workpiece also has a shift component parallel to the worm axis. Through the shift feed (i.e. through the shift component of the relative movement), the grinding worm performs a superimposed rack-like movement in addition to the rolling from the rotation, whereby the generation frequency with which the contact tracks are generated may be changed. This means that the tooth flank waviness wavelength may be distorted (i.e. it may get smaller or larger depending on the shift direction) and that the phase offset may be adjusted via the shift component. In particular, it may be useful to set the phase offset via the shift component if the variation frequency cannot or should not be changed, e.g. if the variation frequency is determined by an unbalance of the grinding worm or results from a thread waviness applied to the grinding worm and may therefore be linked to a worm rotational frequency of the grinding worm, which worm rotational frequency may have to be kept fixed.

In a preferred variant of the method, the grinding worm rotates at a worm rotational frequency, and the deliberate variation of the penetration depth takes place at a variation frequency that is greater than the worm rotational frequency. This makes it possible to set the phase offset with a lower shift feed than in a situation in which the variation frequency corresponds to the worm rotational frequency.

Preferably, the variation frequency is chosen to be so high compared to a rotational frequency of the pre-toothed workpiece that the tooth flank waviness along the respective contact tracks has a plurality of wave periods.

The deliberate variation of the penetration depth may be generated in different ways, wherein combinations of these ways are possible.

In particular, the deliberate variation of the penetration depth may include: generating a deliberate relative additional movement between the pre-toothed workpiece and the grinding worm.

In the present context, the term “relative additional movement” refers to movements that go beyond the movements required to fulfill the law of gearing and beyond the relative movement parallel to the workpiece axis, which is necessary to generate adjacent contact tracks.

In particular, the term “relative additional movements” refers to movements that have a component in the direction of a normal of the tooth flank of the workpiece to be machined.

In particular, the deliberate relative additional movement may be used to change a relative position between the pre-toothed workpiece and the grinding worm along an infeed direction radial to the workpiece axis and/or along an axial direction parallel to the workpiece axis and/or along a shift direction along the worm axis.

In particular, the grinding worm may be moved radially to the workpiece axis along an infeed direction, and the generation of the deliberate relative additional movement may comprise:
exciting a translational vibration of the grinding worm with a vibration component in the infeed direction radial to the workpiece axis.

In particular, if the workpiece has a helical gearing, the grinding worm may alternatively or additionally be configured to perform a movement with a movement component parallel to the workpiece axis, and the generation of the deliberate relative additional movement may comprise:
exciting a translational vibration of the grinding worm with a vibration component parallel to the workpiece axis.

Alternatively or additionally, the grinding worm may be displaceable along a shift direction parallel to the worm axis, and the generation of the deliberate relative additional movement may comprise:
exciting a translational vibration of the grinding worm with a vibration component in the shift direction parallel to the worm axis.

Alternatively or additionally, the generation of the targeted relative additional movement may comprise:
exciting a torsional vibration of the grinding worm about the worm axis.

The pre-toothed workpiece may be arranged on a workpiece spindle, and the generation of the deliberate relative additional movement may alternatively or additionally comprise:
exciting a torsional vibration of the workpiece spindle about the workpiece axis, and/or
exciting a bending vibration of the workpiece spindle, in particular in a direction perpendicular to the workpiece axis, and/or
exciting a translational vibration of the workpiece spindle, in particular with a vibration component along a direction parallel and/or perpendicular to the workpiece axis.

Alternatively or additionally, it is also conceivable to achieve the deliberate variation of the penetration depth using an appropriately dressed grinding worm.

The grinding worm may have a thread waviness on a grinding worm thread flank of a grinding worm thread, whereby the deliberate variation of the penetration depth to generate the tooth flank waviness may comprise:
transferring the thread waviness of the grinding worm thread flank to the tooth flank of the pre-toothed workpiece that is in rolling engagement with the grinding worm.

The method may comprise dressing the grinding worm to produce the thread waviness.

The thread waviness can also be generated either on only one part or on several different parts of the grinding worm thread, or on one or more width regions of the grinding worm, which may then be selectively traversed during the grinding of the workpiece by shifting in the shift direction. For example, each grinding stroke can be assigned a region with a constant thread waviness, or the thread waviness may be designed such that it changes during a grinding stroke.

The relative movement between the grinding worm may take place with a shift feed speed along the shift direction and with an axial feed speed in an axial direction parallel to the workpiece axis, whereby the shift feed speed and the axial feed speed are in such a predetermined diagonal ratio that the thread waviness is mapped onto the tooth flank of the pre-toothed workpiece and the surface structure of the tooth flank is thereby deliberately modified.

The diagonal ratio is the ratio of the shift feed speed of the grinding worm in the shift direction to the axial feed speed of the grinding worm in the axial direction parallel to the workpiece axis. The diagonal ratio may be zero or non-zero.

The advantage of permanently profiling a thread waviness in the grinding worm thread is that the thread waviness may be generated independently of the machining of the pre-toothed workpiece in a separate and less dynamic process and thus, in contrast to the generation of machine-controlled additional movement, lower precision requirements are placed on the machine axes involved in the highly dynamic grinding process.

The method may also comprise:
dressing the grinding worm with a dressing tool, wherein the dressing tool may exhibit radial runout and/or axial runout. In this case, a fixed or variable rotation angle ratio between the dressing tool and the grinding worm may be specified such that the radial runout and/or the axial runout is deliberately used to generate the thread waviness on the grinding worm thread flank.

In one variant, the grinding worm has at least two grinding worm threads, wherein on each of the at least two grinding worm threads a respective thread waviness is generated along a worm contact path, and wherein the at least two grinding worm threads each generate adjacent contact tracks on the tooth flank, wherein each contact track on the tooth flank is associated with one of the at least two worm contact paths, and wherein the thread wavinesss generated on the respective grinding worm threads preferably differ from each other.

To ensure that the at least two grinding worm threads each produce adjacent contact tracks on the tooth flank, the meshing sequence in which the at least two grinding worm threads engage with the tooth flank must be taken into account and a suitable tooth/thread ratio between the pre-toothed workpiece and the grinding worm must be selected.

The worm contact paths preferably each have a worm contact path starting point, which is associated with a contact track starting point of the respective contact track on the tooth flank, wherein the thread waviness of the at least two grinding worm threads at the respective worm contact path starting point are out of phase with one another.

The thread waviness of the at least two grinding worm threads may also have a difference in wavelength. These differences between the grinding worm threads may be specifically mapped to the tooth flank, taking into account the meshing sequence and with a suitable setting of the shift feed, in order to deliberately set the phase offset between the tooth flank waviness of adjacent contact tracks.

Alternatively or additionally, the thread waviness of the at least two grinding worm threads may also have a difference in waviness amplitude. The worm contact path starting points may generally be arranged at different circumferential positions with respect to a circumferential direction of the grinding worm.

In the case of a grinding worm which has at least two grinding worm threads, the method may further comprise:
dressing one of the grinding worm threads of the grinding worm with a constant axial pitch error to produce a protruding grinding worm thread, the axial pitch error being chosen such that the protruding grinding worm thread achieves a greater penetration depth than its preceding and succeeding grinding worm threads with respect to a meshing sequence on the tooth flank, such that the projecting grinding worm thread at least partially grinds over the contact tracks produced by its preceding grinding worm threads.

If the pitch error is chosen in a suitable order of magnitude, all contact tracks between two contact tracks of the protruding grinding worm thread may be ground over. This may lead to the result that only (comparatively wide) contact tracks are produced on the workpiece tooth flank, which were generated by the protruding grinding worm thread, and that the tooth flank waviness is only generated by the protruding grinding worm thread. In this case, the shift feed may be reduced by a factor corresponding to the number of grinding worm threads that engage in a tooth space.

In some embodiments, a thread waviness is generated only on this protruding grinding worm thread. In other embodiments, a thread waviness is generated on each of the at least two grinding worm threads.

Preferably, the deliberate variation of the penetration depth is superimposed with uncontrolled, in particular stochastically occurring, deviations of the penetration depth, wherein the deliberate variation of the penetration depth takes place with a modulation amplitude which lies in a range between 0.2 times and 5 times a fluctuation measure for the uncontrolled deviations of the penetration depth,
wherein the fluctuation measure corresponds in particular to a standard deviation or an interquartile range of the uncontrolled deviations of the penetration depth,
in particular, wherein the fluctuation measure of the uncontrolled deviations of the penetration depth is determined and the modulation amplitude is specifically chosen as a function of the determined fluctuation measure.

By varying the penetration depth in a deliberate (targeted) manner, a suitable base pattern may be generated on the tooth flank, which may be made more diffuse by superimposing the uncontrolled deviations, which leads to an optimization of the noise behavior.

In a further aspect, the present invention provides a machine tool, comprising:
a tool spindle which is configured to receive a grinding worm for rotation about a worm axis;
a workpiece spindle which is configured to receive a pre-toothed workpiece for rotation about a workpiece axis;
an axial slide with an axial drive for generating a relative movement between the tool spindle and the workpiece spindle, the relative movement having an axial component parallel to the workpiece axis, and
a controller configured to perform the method described above.

The machine tool preferably comprises a shift slide with a shift drive for generating a displacement of the grinding worm in a shift direction parallel to the worm axis, wherein the shift drive is configured to excite a translational vibration of the shift slide in the shift direction.

Alternatively or additionally, the axial drive may be configured to excite a translational vibration the axial slide with a vibration component parallel to the workpiece axis.

Alternatively or additionally, the tool spindle may be configured to excite a torsional vibration of the grinding worm about the worm axis.

Alternatively or additionally, the machine tool may have a tool carrier with a tool carrier drive for generating an infeed movement of the grinding worm in an infeed direction radial to the worm axis, wherein the tool carrier drive is configured to excite a translational vibration of the grinding worm in the infeed direction.

Alternatively or additionally, the machine tool may have at least one separate tool vibration module,
which is configured to excite translational vibration of the shift slide and/or the tool spindle in the shift direction, and/or
which is configured to excite a translational vibration of the axial slide with a vibration component parallel to the workpiece axis, and/or
which is configured to excite a translational vibration of the tool carrier in the infeed direction, and/or
which is configured to excite a torsional vibration of the tool spindle about the worm axis.

The machine tool may have a separate tool vibration module for any selection of the above-mentioned forms of excitation or for each of the above-mentioned forms of excitation.

In particular, it is conceivable to excite the shift slide and the tool spindle with different excitation parameters and thus generate a superimposed translational vibration.

The machine tool may alternatively or additionally comprise a workpiece spindle drive for driving the workpiece spindle, wherein the workpiece spindle drive is configured to excite a torsional vibration and/or a bending vibration and/or a translational vibration of the workpiece spindle.

Alternatively or additionally, the machine tool may have at least one separate workpiece vibration module, which is configured to excite a torsional vibration and/or a bending vibration and/or a translational vibration the workpiece spindle.

The machine tool may have a separate workpiece vibration module for any selection of the above-mentioned forms of excitation of the workpiece spindle or for each of the above-mentioned forms of excitation of the workpiece spindle.

In the present context, the term “vibration” refers to (periodic) fluctuations that repeat over time. The vibrations may be harmonic oscillations or have other forms of vibration. The above-mentioned vibrations may each have a vibration frequency which is constant over time or which is deliberately varied over time. Likewise, the above-mentioned vibrations may each have a vibration amplitude which is constant over time or which is deliberately varied over time.

The individual excitation sources and the use of a grinding worm with a thread waviness may be combined with each other as desired. It is also conceivable to deliberately generate vibration beats by superimposing different excitation sources.

It is also conceivable to achieve the deliberate variation of the penetration depth during different grinding strokes in a grinding process using different methods, e.g. to perform a roughing stroke with excitation of a vibration in the shift direction and a finishing stroke with thread waviness on the grinding worm. Different methods may also be used during a grinding stroke to vary the penetration depth in a targeted manner, for example preferably during the finishing stroke, as the latter is responsible for the final surface. Individual, several or all available excitation sources may be switched on and off during the grinding stroke or varied in amplitude and frequency in order to vary the excitation characteristics during the grinding stroke, i.e. across the flank width. This leads to the generation of a more diffuse surface structure with fewer periodic components.

### BRIEF DESCRIPTION OF THE DRAWINGS

Preferred embodiments of the invention are described below with reference to the drawings, which are for explanatory purposes only and are not to be interpreted restrictively. The drawings show:

FIG. 1 a schematic view of a generating grinding machine;

FIG. 2 an enlarged section of FIG. 1;

FIG. 3 a schematic sectional view along a flank line of a tooth flank;

FIG. 4 a schematic representation of a plurality of contact tracks on a tooth flank, spaced apart from one another in the face width direction;

FIG. 5A a schematic representation of the effective contact track widths of a plurality of contact tracks spaced apart from one another in the face width direction on a tooth flank without phase offset between the contact tracks;

FIG. 5B a schematic tooth flank waviness resulting from the periodic variation of a penetration depth between the grinding worm and the workpiece without phase offset between the contact tracks;

FIG. 5C an enlarged section from a longitudinal section along the section line A′-A′ shown in FIG. 5A and FIG. 5B;

FIG. 5D an enlarged section from a longitudinal section along the section line B′-B′ shown in FIG. 5A and FIG. 5B;

FIG. 6A a schematic representation of the effective contact track width of a plurality of contact tracks spaced apart from one another in the face width direction on a tooth flank with a phase offset of 180° between the contact tracks;

FIG. 6B a schematic tooth flank waviness resulting from the periodic variation of the penetration depth with a phase offset of 180° between the contact tracks;

FIG. 6C an enlarged section from a longitudinal section along the section line A″-A″ shown in FIG. 6A and FIG. 6B;

FIG. 6D an enlarged section from a longitudinal section along the section line B″-B″ shown in FIG. 6A and FIG. 6B;

FIG. 7A a schematic frontal view of a grinding worm thread flank of a single grinding worm thread of a grinding worm for one thread pitch of the grinding worm;

FIG. 7B unwrapping of a circular grinding worm surface with a schematically illustrated thread waviness;

FIG. 8 a sectional view of a tooth flank in the face width direction;

FIG. 9A a deliberate periodic variation of the penetration depth depending on a position along a contact track;

FIG. 9B uncontrolled, stochastically occurring deviations of the penetration depth depending on the position along a contact track;

FIG. 9C resulting superposition of the controlled variation from FIG. 9A and the uncontrolled deviations from FIG. 9B, and

FIG. 10 an exemplary illustration of a surface structure of a tooth flank modified using a method according to the invention.

### DESCRIPTION OF PREFERRED EMBODIMENTS

### Example of a Generating Grinding Machine

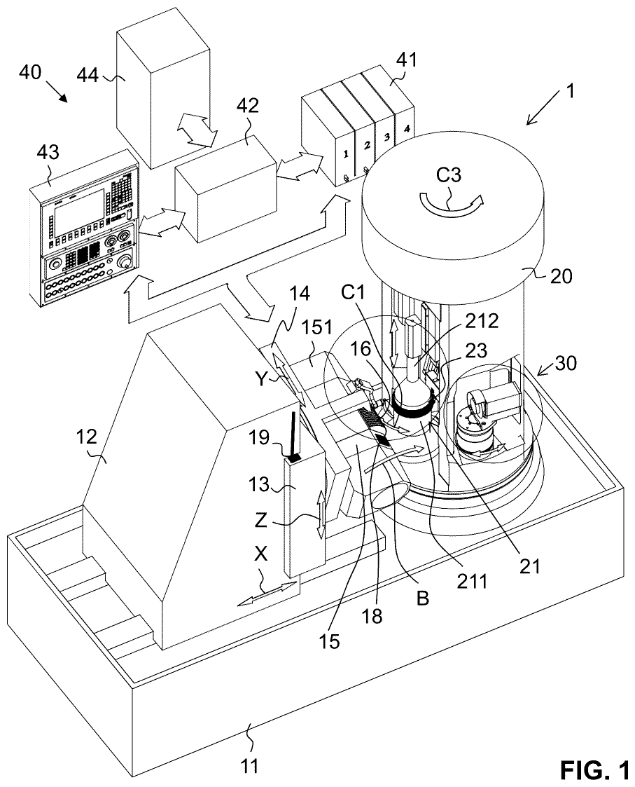

As an example of a machine tool, FIG. 1 shows a generating grinding machine 1, which is also referred to as “machine” in the following. The machine 1 has a machine bed 11 on which a tool carrier 12 is guided for displacement along a radial infeed direction X. The tool carrier 12 carries an axial slide 13, which is guided for displacement along a feed direction Z relative to the tool carrier 12. A grinding head is mounted on the axial slide 13, which can be pivoted about a pivot axis (the so-called A axis) running in parallel to the X direction in order to adapt to the helix angle of the gearing to be machined. The grinding head in turn carries a shift slide 14, on which a tool spindle 15 can be moved along a shift direction Y relative to the grinding head. A worm-shaped profiled grinding wheel (grinding worm) 16 is mounted on the tool spindle 15. The grinding worm 16 is driven by the tool spindle 15 to rotate about a worm axis B.

The machine bed 11 also carries a pivoting workpiece carrier 20 in the form of a turret, which is pivotable about a pivot axis C3 between at least three positions. Two identical workpiece spindles are mounted diametrically opposite each other on the workpiece carrier 20, of which only one workpiece spindle 21 is visible in FIG. 1. A workpiece may be clamped on each of the workpiece spindles and driven to rotate about a workpiece axis C1. In the machine shown in FIG. 1, the feed direction Z runs parallel to the workpiece axis C1. However, the feed direction Z, along which the axial slide 13 is displaceably guided, may also be tilted with respect to the workpiece axis C1. The workpiece spindle 21 visible in FIG. 1 is in a machining position in which a workpiece 23 clamped thereon can be machined with the grinding worm 16. The other workpiece spindle, which is offset by 180° and not visible in FIG. 1, is in a workpiece change position, in which a finished workpiece may be removed from this spindle and a new blank may be clamped onto it. A dressing device 30 is mounted offset by 90° to the workpiece spindles.

The machine 1 therefore has a large number of moving components, such as slides or spindles, which are movable in a controlled manner by corresponding drives. These drives are often referred to in the trade as “NC axes”, “machine axes” or abbreviated as “axes”. In some cases, this term also includes the components driven by the drives, such as slides or spindles.

The machine 1 also has a large number of sensors. As an example, only two sensors 18 and 19 are schematically indicated in FIG. 1. Sensor 18 is a vibration sensor for detecting vibrations of the housing of the grinding spindle 15. Sensor 19 is a position sensor for detecting the position of the axial slide 13 relative to the tool carrier 12 along the Z direction.

However, the machine 1 also comprises a large number of other sensors. These sensors comprise, in particular, further position sensors for detecting an actual position of one linear axis each, rotation angle sensors for detecting a rotational position of one rotation axis each, current sensors for detecting a drive current of one axis each and further vibration sensors for detecting vibrations of one driven component each.

All driven axes of the machine 1 are digitally controlled by a machine controller 40. The machine controller 40 comprises several axis modules 41, a control computer 42 and a control panel 43. The control computer 42 receives operator commands from the control panel 43 as well as sensor signals from various sensors of the machine 1 and uses them to calculate control commands for the axis modules 41. It also outputs operating parameters to the control panel 43 for display. The axis modules 41 each provide control signals for one machine axis at their outputs.

A monitoring device 44 is connected to the control computer 42 and performs various monitoring tasks during operation of the machine 1.

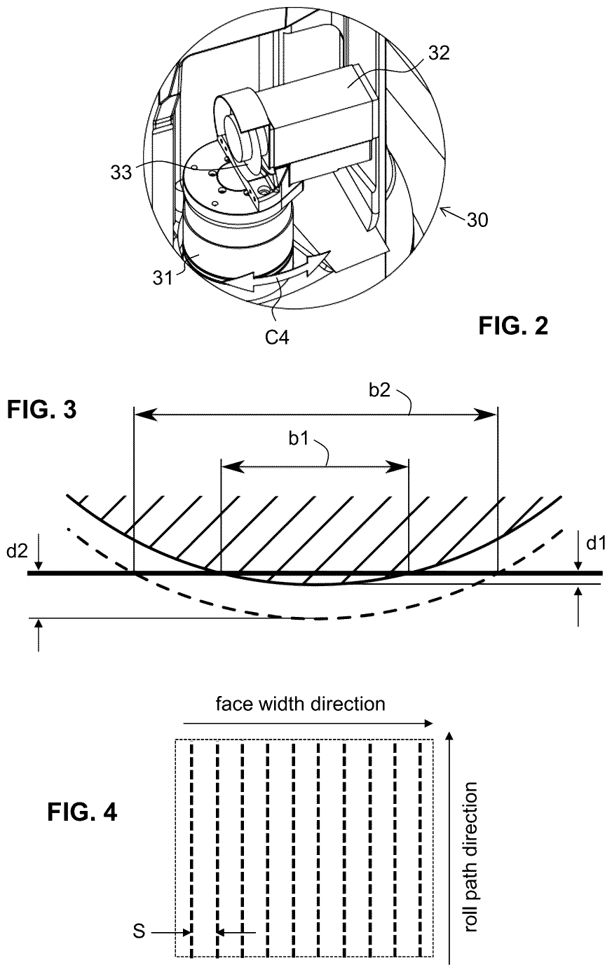

FIG. 2 shows an enlarged section of FIG. 1. The dressing device 30 can be seen particularly clearly here. A dressing spindle 32, on which a disc-shaped dressing tool 33 is clamped, is arranged on a swivel drive 31 so that it can swivel about an axis C4. Instead or in addition, a stationary dressing tool can also be provided, in particular a so-called head dresser, which is intended to engage only with the head areas of the grinding worm threads of the grinding worm in order to dress these head areas.

### Contact Tracks with Varying Penetration Depths

In a worm drive, as is the case with a pairing of an externally toothed spur gear (the pre-toothed workpiece) and the grinding worm, point contact occurs in the case of non-parallel axes of the pre-toothed workpiece and the grinding worm. When rolling through the pairing, the contact point moves along a path geometrically determined by the pairing over the tooth flank of the pre-toothed workpiece and over the grinding worm flank of the grinding worm. In the present context, the path on the tooth flank is referred to as the contact track and the path on the grinding worm flank as the worm contact path. With each revolution, a new contact track is created on the tooth flank and material is removed accordingly.

FIG. 3 shows a schematic sectional view along a flank line of the tooth flank. As shown in FIG. 3, the individual contact track each has an individual contact track width b1, b2, which depends on a penetration depth d1, d2 between the grinding worm 16, represented schematically in FIG. 3 by an arc of a circle, and the pre-toothed workpiece 23. A first single contact track width b1 in FIG. 3 corresponds to a first penetration depth d1, while a second single contact track width b2 corresponds to a second penetration depth d2. FIG. 3 clearly shows that for a single contact track, an increase in the penetration depth leads to a widening of the contact track. In FIG. 3, however, the relationship between the single contact track width and the penetration depth of the grinding worm is not shown to scale for illustrative purposes. A monotonic relationship between the penetration depth and the single contact track width may be assumed in the realistic orders of magnitude of the penetration depth that are usual for the generating grinding process.

FIG. 4 schematically shows a number of adjacent contact tracks as dashed lines. By generating a relative movement between the grinding worm and the pre-toothed workpiece, a new contact track is created with each rotation of the workpiece, the new contact track being spaced from the previously created contact track by a contact track distance S in the workpiece face width direction. The contact track distance S is determined by the axial component of the relative movement parallel to the workpiece axis C1. The relative movement may, but does not necessarily have to be constant in time. If the pre-toothed workpiece has a spur gear and no relative movement parallel to the workpiece axis C1 takes place during the generation of the respective contact track, the contact tracks run in the roll path direction and therefore perpendicular to the flank lines, as shown in FIG. 4. If a relative movement parallel to the workpiece axis C1 occurs during the generation of the respective contact tracks and/or if the pre-toothed workpiece has a helical gearing, the contact tracks generally are inclined with respect to the roll path direction and thus inclined with respect to the flank lines. If the relative movement parallel to the workpiece axis C1 is constant, the contact tracks run parallel to each other at a constant distance.

If the penetration depth is not varied along the contact tracks, all contact tracks have the same contact track width. If, however, the penetration depth is varied along the contact tracks, a tooth flank waviness occurs along the respective contact track, resulting in an effective contact track width b_{eff}, wherein two cases can be distinguished:

### Case 1—No Phase Offset Between Tooth Flank Waviness of Adjacent Contact Tracks

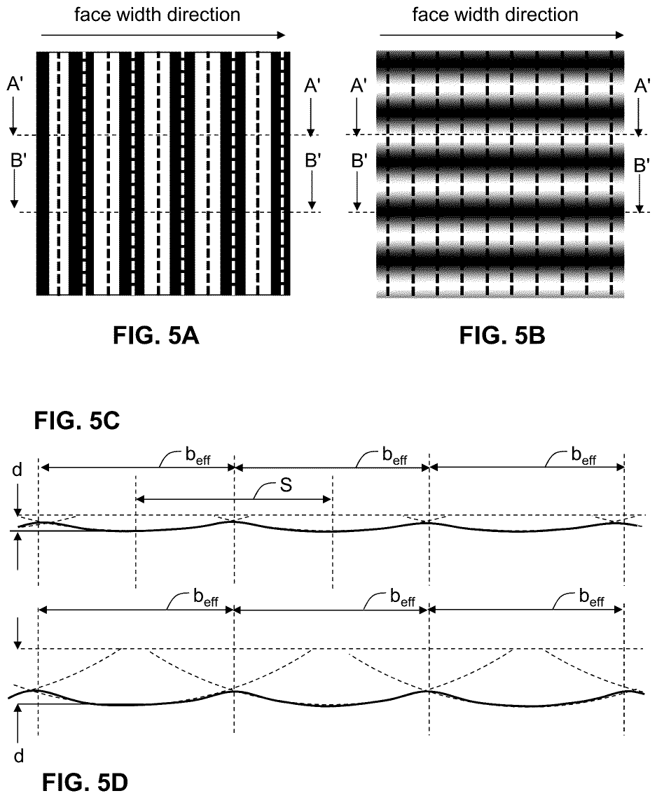

FIGS. 5A-5D illustrate a case in which the penetration depth d varies periodically along the respective contact tracks and thus a tooth flank waviness is generated, although there is no phase offset between the tooth flank waviness of adjacent contact tracks. FIG. 5A illustrates the effective contact track width b_{eff} of the respective dashed contact tracks by means of alternating black and white stripes. FIG. 5B schematically shows the surface structure resulting from the periodic variation of the penetration depth d with wave crests shown in light shading and wave troughs shown in dark shading. FIG. 5C shows an enlarged section of a longitudinal section along the intersection line A′-A′ (wave crest) shown in FIG. 5A and FIG. 5B. FIG. 5D shows an enlarged section from a longitudinal section along the section line B′-B′ (wave trough) shown in FIG. 5A and FIG. 5B. In both FIG. 5C and FIG. 5D, the machined tooth flank surface is shown as a solid line. Although the penetration depth d in the longitudinal section along the wave trough shown in FIG. 5D is greater than in the longitudinal section along the wave crest shown in FIG. 5C, the effective contact track width b_{eff} remains constant along the contact tracks. This is the case because a preceding contact track is partially ground over when the subsequent adjacent contact track is generated due to the fact that in this example the contact track spacing S between adjacent contact tracks is smaller than the actual contact track width that a contact track would have if it were generated without overlapping with adjacent contact tracks (as shown in FIG. 3), and since the variation of the penetration depth d is “in-phase”, i.e. without phase offset between the tooth flank waviness of adjacent contact tracks. As a consequence, the wave troughs and wave crests of the adjacent contact tracks form continuous wavefronts, i.e. lines of constant phase, which are not interrupted in the face width direction, wherein only small amplitude modulations occur along the wave front (visible in FIG. 5C and FIG. 5D in longitudinal section, not shown in FIG. 5B), which depend on the curvature of the grinding worm at the contact point and are not shown to scale here. Such continuous wavefronts on the surface of the tooth flank often have a detrimental effect on the noise behavior of the gear in a gearbox.

### Case 2—Phase Offset Between Tooth Flank Waviness of Adjacent Contact Tracks is Present

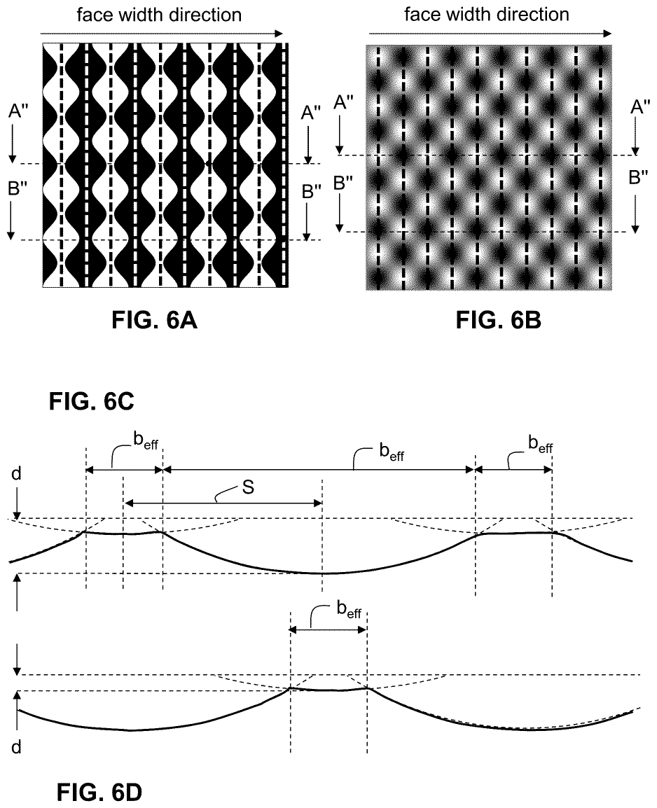

FIGS. 6A-6D schematically illustrate an embodiment in which the penetration depth d varies periodically along the respective contact tracks and thus a tooth flank waviness is generated, wherein the phase offset between the tooth flank waviness of adjacent contact tracks is 180° in each case. FIG. 6A schematically illustrates the effective contact track width b_{eff} of the respective dashed contact tracks by means of alternating black and white stripes. FIG. 6B schematically shows the surface structure resulting from the periodic variation of the penetration depth d with wave crests shown in light shading and wave troughs shown in dark shading. FIG. 6C shows an enlarged section of a longitudinal section along the intersection line A″-A″ shown in FIG. 6A and FIG. 5B. FIG. 6D shows an enlarged section from a longitudinal section along the section line B″-B″ shown in FIG. 6A and FIG. 6B. In both FIG. 6C and FIG. 6D, the machined tooth flank surface is shown as a solid line. In contrast to the situation shown in FIGS. 5A-5D, the wave troughs and wave crests of the adjacent contact tracks do not form continuous wavefronts in the width direction here. Instead, the phase offset of 180° results in a chessboard-like surface structure, as shown in FIG. 6B.

### Deliberate Variation of the Penetration Depth

In a stationary generating grinding process, i.e. a generating grinding process with constant process parameters, a certain constant period of time t elapses between the generation of adjacent contact tracks on the same tooth flank. The contact tracks are therefore generated with a generation frequency

$${f}_{K} = \frac{1}{{t}_{K}} .$$

More specifically, this generation frequency f_{K} describes the frequency with which the contact points between the grinding worm and the pre-toothed workpiece cross a randomly selected flank line in the generating grinding process. In the case of a spur gear without shift feed, the generation frequency f_{K} corresponds to the rotational frequency f_{C}_{₁} of the workpiece. In general, however, the generation frequency f_{K} may depend on a shift feed speed in the shift direction and/or, in the case of helical gears, on the helix angle.

In order to deliberately vary the penetration depth, a periodic vibration with a variation frequency f_{V} is superimposed on the stationary generating grinding process, which leads to a periodic relative movement between the grinding worm and the pre-toothed workpiece in a direction normal to the surface of the grinding worm and workpiece at the point of contact. The vibration may be generated in various ways. The ratio of the variation frequency f_{V} to the generation frequency f_{K} may be expressed as the order P of the frequency f_{V} with respect to the frequency f_{K}:

$$P = \frac{{f}_{V}}{{f}_{K}}$$

If this order P is an integer, the phase offset between the adjacent contact tracks viewed along any flank line of the tooth flank is Δφ=0 (case 1 explained above).

As soon as a non-integer value is selected for the order P, the phase offset between the adjacent contact tracks viewed along any flank line of the tooth flank is Δφ≠0 (case 2 explained above).

The phase offset Δφ may be determined as follows:

$$Δ φ = ( P - floor ( P ) ) \cdot 2 π$$

where floor(x):=max{k∈ [symbol] |k≤x} represents the rounding function and floor(P) thus corresponds to an integer order component. The non-integer order component, i.e. (P−floor(P)) therefore determines the phase position of the contact tracks relative to each other.

Thus, for a desired phase offset Δφ and a desired integer order component floor(P) a possible variation frequency f_{V} may be determined, since the generation frequency f_{K} is known from the kinematic conditions of the generating grinding process:

$${f}_{V} = {f}_{K}^{P} = {f}_{K} ( \frac{Δφ}{2 π} + floor ( P ) )$$

### Deliberate Variation of the Penetration Depth by Additional Movements During Workpiece Processing

The depth of penetration may be varied in various ways.

In one embodiment of the method, the penetration depth is varied by generating a deliberate relative additional movement between the pre-toothed workpiece and the grinding worm.

The machine tool 1 shown in FIG. 1 comprises a shift slide 14 with a shift drive for generating a displacement of the grinding worm in the shift direction Y parallel to the worm axis B, wherein the shift drive may be configured to excite a translational vibration of the shift slide 14 in the shift direction Y in order to generate the targeted relative additional movement.

The penetration depth may be varied, particularly in the case of helical gears, by additionally or alternatively exciting a translational vibration of the axial slide 13 with a vibration component parallel to the workpiece axis C1 by an axial drive configured for this purpose. The translational vibration may take place along the feed direction Z, wherein the feed direction Z may run in parallel to the workpiece axis C1 or may be tilted with respect to the workpiece axis C1.

Also, the tool spindle 15 may be configured to excite a torsional vibration of the grinding worm 16 about the worm axis B. For this purpose, the tool spindle drive may have a frequency converter, which may be used to generate the torsional vibration of the grinding worm 16.

In addition or alternatively, the tool carrier drive of the tool carrier 12 may be configured to excite a translational vibration of the grinding worm 16 in the feed direction X in order to deliberately vary the penetration depth.

Alternatively or additionally, the machine tool 1 may have a separate tool vibration module 151, which is configured to excite a translational vibration of the shift slide 14 and/or the tool spindle 15 in the shift direction Y and/or to excite a torsional vibration of the tool spindle 15 about the worm axis B. In order to have to excite as little mass as possible and to keep the transmission path from the tool vibration module 151 to the point of contact between the grinding worm and the workpiece as short as possible, direct excitation of the tool spindle 15, as indicated in FIG. 1, is particularly advantageous. To excite the vibration, the tool vibration module 151 may, for example, comprise a piezo actuator or an electrodynamic shaker. In order to excite a torsional vibration, masses arranged eccentrically to the worm axis B and coupled to the tool spindle 15 may also be used, which masses may be excited by vibration modules to produce translational vibrations directed in the direction of rotation. Alternatively or additionally, a flywheel mounted so as to be rotatable and coupled to the tool spindle, the flywheel being excited via a piezo actuator or an electrodynamic shaker, is also conceivable.

Alternatively or additionally, the machine tool 1 may have a separate tool vibration module with a piezo actuator or an electrodynamic shaker, which is configured to excite a translational vibration of the axial slide 13 with a vibration component parallel to the workpiece axis C1, and/or which is configured to excite a translational vibration of the tool carrier 12 in the infeed direction X (not explicitly shown in FIG. 1).

In FIG. 1, the workpiece spindle 21 has a workpiece spindle drive 211 which is configured to excite a torsional vibration of the workpiece spindle 21, whereby the torsional vibration leads to a rotational vibration of the pre-toothed workpiece 23 clamped on the workpiece spindle about the workpiece axis C1. The workpiece spindle drive 211 may comprise a frequency converter, which may be used to generate the torsional vibration. Alternatively, rotational excitation via an appropriately configured active element such as a piezo actuator or an electrodynamic shaker is also conceivable.

Furthermore, the workpiece spindle drive 211 may be configured to excite a bending vibration of the workpiece spindle 21 to, whereby the bending vibration leads to a precession and/or nutation of the workpiece axis C1 and thus to a tilting and/or a displacement of the workpiece 23 relative to the grinding worm.

The workpiece spindle drive 211 may also be configured to excite a translational vibration of the workpiece spindle 21, with the translational vibration preferably taking place in parallel to the worm axis B in the shift direction Y, whereby the workpiece moves back and forth relative to the grinding worm along the shift direction Y.

Alternatively or additionally, the machine tool may have a separate workpiece vibration module 212 which is configured to excite a torsional vibration and/or a bending vibration and/or a translational vibration of the workpiece spindle as described above. For this purpose, the workpiece vibration module may comprise, for example, piezo actuators which act radially on a bearing of the workpiece spindle 21 and thus excite a bending vibration and/or radial translational vibration, and/or which act axially on a bearing of the workpiece spindle 21 and thus excite a translational axial vibration. The workpiece vibration module may also be an electrodynamic shaker coupled to the lower end of the workpiece spindle 21 for axial and/or radial excitation of the workpiece spindle 21. The axial excitation leads to an axial translational movement, whereas the radial excitation leads to a radial translational movement and/or a tilting movement of the workpiece axis C1 about a virtual bearing point and/or a bending vibration of the workpiece axis C1.

Taking into account the process parameters used in the generating grinding process, the generation frequency f_{K} may be determined. By specifically choosing the variation frequency f_{V} as described above, the torsional vibration and/or bending vibration and/or translational vibration leads to a deliberate variation of the penetration depth with the desired phase offset Δφ between the respective adjacent contact tracks due to the resulting relative additional movements between the workpiece 23 and the grinding worm 16.

### Deliberate Variation of the Penetration Depth Via Suitable Dressing of the Grinding Worm

In particular, if a tooth flank waviness with a high order with regard to the worm rotational frequency f_{S} is required, the high-frequency vibrations with a precisely defined modulation amplitude in the micrometer range may place high requirements on the machine axes involved.

It is therefore alternatively or additionally conceivable to achieve the deliberate variation of the penetration depth by dressing the grinding worm accordingly.

To generate the thread waviness on the grinding worm thread, a dressing wheel which exhibits radial runout and/or axial runout may be used as the dressing tool, whereby a fixed rotation angle ratio between the dressing tool and the grinding worm is chosen such that the radial runout and/or the axial runout deviation may be deliberately used to generate the thread waviness on the grinding worm thread flank. Alternatively, the thread waviness may also be generated by line dressing or by corresponding relative movements between the dressing tool and the grinding worm.

For dressing, a dressing tool may also be used which has a dressing flank surface with a wave-shaped dressing flank modification that is transferred to the grinding worm during dressing. Such a dressing tool may, for example, be manufactured in a positive process, wherein the dressing flank modification may be deliberately generated by means of a conditioning tool, in particular a thin rotating conditioning disk that is perpendicular to the dressing flank surface. In particular, the dressing tool may be driven to rotate about a dressing axis of rotation, while the conditioning tool is driven to rotate about a conditioning axis of rotation of the conditioning tool and is fed in a direction which has a component in normal direction to the dressing flank surface in order to generate the dressing flank modifications by removing material from the dressing flank surface. With regard to the considerations underlying this procedure and further possible embodiments, reference is made to the patent application filed on the same date as the present application by the same applicant with the title “Dressing tool for dressing a grinding worm for the generating machining of pre-toothed workpieces”, the content of which is incorporated in its entirety into the present disclosure by reference.

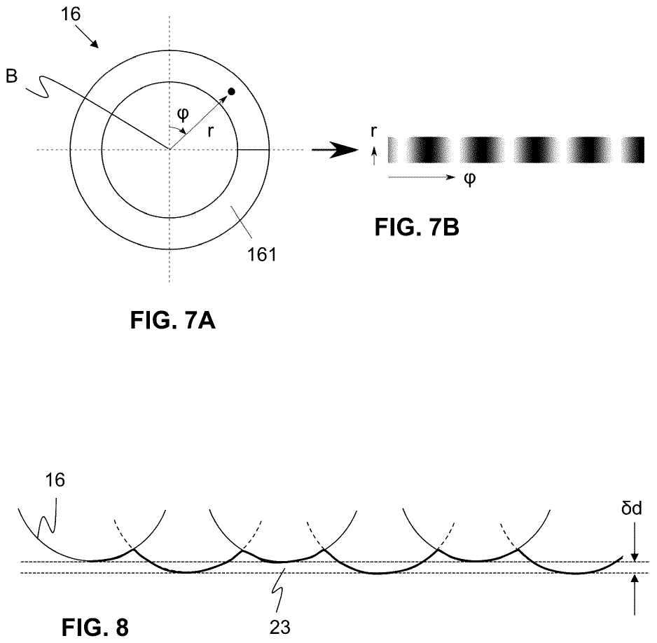

FIG. 7A shows a schematic frontal view of a grinding worm thread flank of a single worm thread of a grinding worm 16 for one thread pitch of the grinding worm. The grinding worm thread flank 161 has a annular shape on a projection plane perpendicular to the worm axis B, the annular shape defining a radial direction with a radial coordinate r and a circumferential direction with an angular coordinate q. The grinding worm thread flank 161 in unwrapped form is shown in FIG. 7B and has, by way of example, a thread waviness that is periodic in the circumferential direction with wavefronts that run in the radial direction. Alternatively, the thread waviness may also have wavefronts that are inclined at any angle with respect to the radial direction.

The thread waviness is fixed in space with respect to the grinding worm flank and has a wavelength of λ_{S} in the circumferential direction.

The wavelength λ_{S} of the thread waviness on the grinding worm thread flank of the grinding worm may be converted for one revolution of the grinding worm into a waviness angle θ_{S} with respect to the worm axis B using a length U_{S} of the grinding worm thread along the circumferential direction at the above-mentioned radial distance, at which the wavelength is defined:

$${θ}_{s} = \frac{{λ}_{S}}{{U}_{S}} 2 π$$

By shifting the grinding worm in the shift direction Y or in the feed direction Z with a suitable ratio of shift feed speed and axial feed speed during workpiece machining, the thread waviness on the grinding worm flank may be mapped onto the pre-toothed workpiece being rolling engagement in order to generate a targeted tooth flank waviness. What is relevant is the waviness on the grinding worm flank along the worm contact path on the grinding worm thread, this waviness preferably having a constant wavelength λ_{S}′ along the worm contact path. The worm contact path may generally be tilted with respect to the circumferential direction, whereby the wavelength in the circumferential direction λ_{S} differs from the wavelength along the worm contact path λ_{S}′.

A worm contact path on the grinding worm path is associated with a contact track on the tooth flank of the workpiece. This means that the waviness is transferred from the worm contact path along the contact track to the workpiece flank. If a description of the contact track via the roll path is used, the generated tooth flank waviness along the contact track has a wavelength λ_{Z} which can be expressed as

$${λ}_{Z} = S \cdot {λ}_{S}^{′} ,$$

where S is a scaling factor that depends exclusively on the ratio of the length of the contact track along the roll path to the length of the worm contact path.

### Grinding Worm with Exactly One Grinding Worm Thread

If, for example, the grinding worm has exactly one grinding worm thread (single-start grinding worm) and a grinding worm thread flank of this grinding worm thread has a thread waviness, this thread waviness is transferred to the tooth flank of the workpiece without phase offset from contact track to contact track, provided no shift feed takes place. If, on the other hand, shift feed takes place, i.e. if the grinding worm moves in parallel to the worm axis B, this leads to a continuous displacement of the worm contact path on the grinding worm flank of the grinding worm thread during the relative movement between the grinding worm and the workpiece in parallel to the workpiece axis C1. However, since the thread waviness is fixed relative to the grinding worm flank and therefore a relative displacement of the worm contact path with respect to the thread waviness occurs, the thread waviness is now mapped onto the tooth flank with a phase shift due to the shift feed and there is effectively a phase offset Δφ between the tooth flank waviness between the tooth flank waviness of adjacent contact tracks on the tooth flank surface of the workpiece.

If a section profile of the grinding worm is viewed along the worm axis B (axial section) and the distance between two points on the same radius on two consecutive grinding worm flanks in the section profile is measured, one obtains the axial pitch pₓ of the grinding worm. If the grinding worm is shifted by exactly one axial pitch pₓ in the direction of the worm axis, the worm contact path is shifted exactly by an angle of 2π on the grinding worm thread in the circumferential direction.

For a shift of the worm contact path, which results in a desired phase offset Δφ between the tooth flank waviness of adjacent contact tracks on the tooth flank surface of the workpiece, the following shift path x_{y} in shift direction Y is required:

$${x}_{y} = {p}_{x} \cdot \frac{{θ}_{s} \cdot \frac{Δ φ}{2 π}}{2 π} = \frac{{p}_{x} \cdot {λ}_{S} \cdot Δφ}{2 π \cdot {U}_{S}}$$

This shift path x_{y} must be covered within the time span t_{K}. This results in a shift feed speed v_{y} of

$${v}_{y} = \frac{{x}_{y}}{{t}_{K}} = \frac{{p}_{x} \cdot {λ}_{S} \cdot Δφ}{2 π \cdot {U}_{S} \cdot {t}_{K}} ,$$

where the phase offset Δφ and the waviness angle θ_{S} are to be inserted in radians.

### Grinding Worm with at Least Two Grinding Worm Threads

If a multi-start grinding worm is used, this has several effects: To obtain the pitch of one thread, the axial pitch pₓ is multiplied by the number n of grinding worm threads. With a multi-start grinding worm, the pitch is therefore a factor n higher than with a single-start grinding worm. At the same worm rotational frequency, a worm thread of a multi-start grinding worm moves faster through the mesh compared to the worm thread of a single-start grinding worm, wherein its geometric length in relation to the workpiece increases only insignificantly. This means that the worm gear is in mesh for a shorter time at the same workpiece rotational speed, which is why the worm contact path is shorter in relation to one revolution of the grinding worm. If the worm contact path on the grinding worm becomes shorter, it contains, for the same wavelength, fewer wave periods that are imaged onto the workpiece. Thus, the wavelength of the waviness along the worm contact path of a multi-start grinding worm must be reduced accordingly if the same phase offset Δφ is to be achieved with the same shift feed as with a single-start grinding worm.

The worm contact paths further have worm contact path starting points that are offset from each other by an angle Δα=2π/n in the circumferential direction of the grinding worm. The waviness at the respective worm contact path starting points of the worm contact paths, which come into meshing engagement one after the other with regard to a meshing sequence of the grinding worm threads, may be phase-shifted relative to each other. If grinding is carried out without shift feed, this phase difference may be used directly to generate a phase offset Δφ≠0 because if the waviness of the different grinding worm threads have the same wavelength, this phase difference between the worm contact path starting points is transferred accordingly to the tooth flank.

An additional shift feed leads to an additional phase offset as described above, which is superimposed on the phase offset caused by the phase difference of the waviness on the successively meshing grinding worm threads.

In addition, with several grinding worm threads, at least one of the grinding worm threads may protrude relative to the others, i.e. instead of a perfectly regular arrangement of the grinding worm threads along the worm axis B, at least one of the grinding worm threads may be displaced along the worm axis B due to an axial pitch error. FIG. 8 again shows a sectional view of a machined tooth flank (solid line) in the face width direction, whereby every second contact track was generated by the protruding worm thread and thus has a penetration depth d that is greater by a penetration difference od than the penetration depth of its adjacent contact tracks.

### EXAMPLES—GENERATION OF DESIRED TOOTH FLANK WAVINESS

### Example 1: Generation of 180° Phase-Shifted Tooth Flank Waviness Via Relative Additional Movements

The process parameters of the generating grinding process may be chosen arbitrarily, but are constant. This allows the time span t_{K} or the generation frequency f_{K} to be determined. According to the above formula, the non-integer component of the order for a phase offset of Δφ=π (180°) is determined as follows:

$$( P - floor ( P ) ) = \frac{Δφ}{2 π} = \frac{π}{2 π} = 0.5$$

The phase offset can therefore be set with the orders P=i+0.5 with

$$i ∈ {ℕ}_{0}^{+} .$$

This allows the variation frequency f_{V} of the external excitation to be determined:

$${f}_{V} = P \cdot {f}_{K} = ( i + 0.5 ) \cdot {f}_{K}$$

Preferably, the order P is selected so high (preferably higher than the gear mesh order) that several wave periods are generated per contact track on the tooth flank.

### Example 2: Generation of 90° Phase-Shifted Tooth Flank Waviness Via Additional Movements

Here, the phase offset is

$$Δ φ = \frac{π}{2} .$$

With a non-integer part of the order of 0.25, this results in the following variation frequency f_{V}:

$${f}_{V} = P \cdot {f}_{K} = ( i + 0.25 ) \cdot {f}_{K}$$

### Example 3: Generation of Tooth Flank Waviness with Non-Constant Phase Offset Via Additional Movements

The relationships explained above apply, wherein the corresponding variables are now dependent on a time variable t:

$$P ( t ) = \frac{{f}_{V} ( t )}{{f}_{K} ( t )}$$

This time dependency may be achieved either by transient/non-stationary process parameters such as a time-dependent rotational frequency f_{S}(t) and/or a time-dependent shift feed rate v_{y}(t) and/or a time-dependent axial feed rate. These lead to a time-dependent rotational frequency of the workpiece via the rolling coupling. If a separate tool vibration module and/or workpiece vibration module is used, their external excitation frequencies may also be chosen to be time-dependent.

In order to obtain a non-constant phase offset Δφ≠0 of the tooth flank waviness of adjacent contact tracks along the virtual reference line defined above, a time dependence of the variation frequency f_{V}(t) and f_{K}(t) in itself is not necessarily sufficient:

For example, the time-dependent variation frequency f_{V}(t) may periodically modulated:

$${f}_{V} ( t ) = {f}_{V , 0} + {A}_{m o d} sin ( 2 π {f}_{m o d} t ) ,$$

where f_{V,0} represents the fundamental variation frequency, f_{mod} represents a modulation frequency and A_{mod} denotes a corresponding amplitude term of the frequency modulation.

If both the order

$$P = \frac{{f}_{V}}{{f}_{K}}$$

as well as the modulation order

$${P}_{M} = \frac{{f}_{m o d}}{{f}_{V , 0}}$$

are integers, there is no phase offset between the tooth flank waviness of adjacent contact tracks, i.e. Δφ=0. If, on the other hand, the order P and/or the modulation order P_{M} is not an integer, a periodically modulated, non-constant phase offset Δφ≠0 occurs.

The time-dependent variation frequency f_{V}(t) may be stochastically modulated instead of periodically modulated, whereby a stochastically modulated, non-constant phase offset Δφ is generated.

It is also conceivable to vary the amplitude term A_{mod} of the frequency modulation in time.

The same considerations apply mutatis mutandis to the time-dependent generation frequency f_{K}(t) which may also be periodically or stochastically modulated.

This results in a large number of degrees of freedom, which may be used to create a surface structure with a diffuse appearance by generating a non-constant phase offset Δφ≠0.

### Example 4: Generation of Tooth Flank Waviness Phase-Shifted by 180° or 90° with an Appropriately Modified Grinding Worm

In the case of a single-start grinding worm, for example, a shift feed speed v_{y} can be chosen according to the relationships described above:

$${v}_{y} = \frac{{x}_{y}}{{t}_{K}} = \frac{{p}_{x} \cdot {λ}_{S} \cdot Δφ}{2 π \cdot {U}_{S} \cdot {t}_{K}}$$

wherein Δφ=180° resp. Δφ=90° is used.

Alternatively, a multi-start grinding worm may be used in which the waviness of the grinding worm threads that engage directly one after the other along the worm contact paths are each 180° or 90° out of phase with one another. If a multi-start grinding worm is used in which the waviness of the grinding worm threads that engage directly one after the other along the worm contact paths are out of phase with each other, but not by 180° or 90°, the difference for generating the desired phase offset of 180° or 90° may be compensated by a shift feed speed v_{y} calculated according to the formula above.

### Example 6: Generation of Waviness with Non-Constant Phase Offset with an Appropriately Modified Grinding Worm

By varying the speed ratio between a modified dressing tool and the grinding worm during dressing, a waviness may be generated on the grinding worm flank which has a varying, i.e. non-constant wavelength along the worm contact path. The relationships explained above apply to the transfer of the waviness from the worm contact path on the grinding worm flank to the contact track on the workpiece, resulting in a non-constant phase offset Δφ between the tooth flank waviness of adjacent contact tracks on the tooth flank of the workpiece. An additional shift feed may also be used to generate an additional phase offset.

A single-start or multi-start grinding worm may also be used here, in which the waviness of the grinding worm threads that engage directly one after the other are phase-shifted along the worm contact paths.

### Superposition with Uncontrolled Stochastic Processes

In a particularly preferred embodiment, the deliberate variation of the penetration depth is superimposed with uncontrolled, in particular stochastically occurring, deviations of the penetration depth d in order to produce a particularly diffuse surface structure with optimized noise behavior.

These uncontrolled deviations in the penetration depth d may be based on deviations in the dressing process of the grinding worm, for example due to
guiding deviations in shift direction Y during dressing (Y-axis), which may lead to local axial pitch errors, and/or
guiding deviations of the tool spindle 15, which may also lead to local axial pitch errors, and/or
deviations of the dressing tool 33 in the mounted state, comprising:
   deviation of the dressing tool 33 itself, and/or
   deviation when clamping the dressing tool 33, and/or
   deviations of the dressing spindle 32.

Alternatively or additionally, these uncontrolled deviations in penetration depth may be based on deviations during grinding of the pre-toothed workpiece, for example due to
deviations in the rolling coupling, comprising:
   deviation in a drive of the workpiece spindle 21, and/or
   deviation in a drive of the shift slide 14, and/or
   deviations in the worm rotational frequency fₛ, and/or
   deviations in infeed direction X, and/or
   deviations in the axial drive of the axial slide 13, and/or
unwanted vibrations from peripheral devices in the machine tool 1, and/or
   structural vibrations of the machine excited by the drives.

Ideally, for the deliberate variation of the penetration depth a modulation amplitude is chosen which lies in a range between 0.2 times and 5 times a fluctuation measure for the uncontrolled deviations of the penetration depth d, wherein the fluctuation measure corresponds in particular to a standard deviation or an interquartile range of the uncontrolled deviations of the penetration depth d.

In a preferred embodiment of the method, the fluctuation measure of the uncontrolled deviations of the penetration depth d is determined and the modulation amplitude is specifically selected as a function of the determined fluctuation measure.

Typical values for the fluctuation measure may be between 0.1 μm and 10 μm, in particular between 0.3 μm and 3 μm.

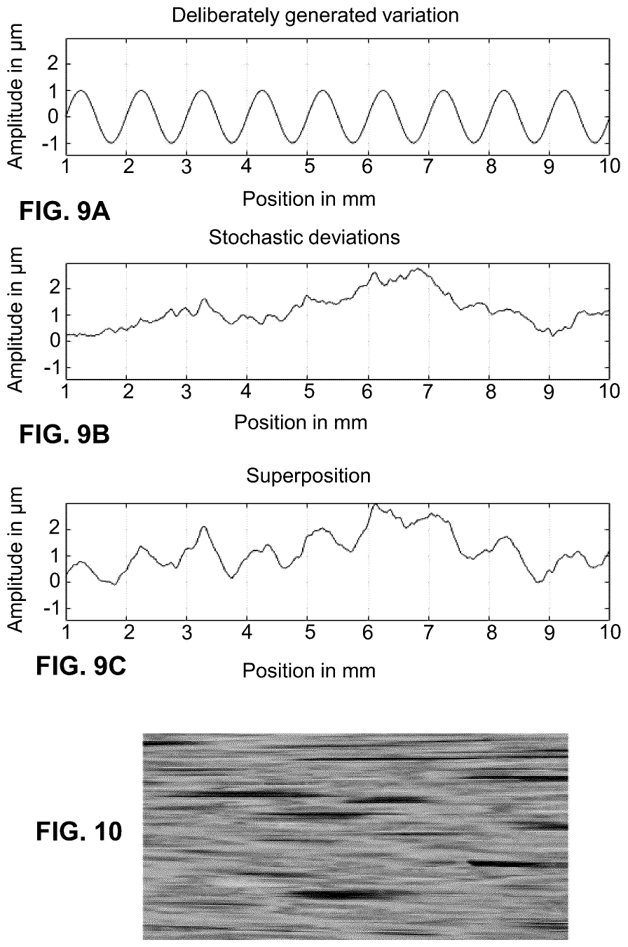

FIGS. 9A-9C illustrate such a superposition situation: FIG. 9A shows the deliberately generated variation of the penetration depth d as a function of a position along the roll path, wherein in this example the penetration depth varies sinusoidally with a modulation amplitude of 1 μm. FIG. 9B shows uncontrolled, stochastically occurring deviations of the penetration depth d. The standard deviation of the uncontrolled deviations of the penetration depth d is 0.44 μm in this example. FIG. 9C shows a resulting superposition of the deliberate variation and the uncontrolled deviations.

FIG. 10 shows an image of a real, measured tooth flank with a particularly diffuse surface structure modified using a method according to the invention.

LIST OF REFERENCE SINGS

| | | | |
|---|---|---|---|
| 1 | generating grinding machine | 40 | machine control |
| 11 | machine bed | 41 | axis modules |
| 12 | tool carrier | 42 | control computer |
| 13 | axial slide | 43 | control panel |
| 14 | shift slide | 44 | monitoring device |
| 15 | tool spindle | B | worm axis |
| 151 | tool vibration module | C1 | workpiece axis |
| 16 | grinding worm | C3 | swivel axis |
| 161 | grinding worm flank | C4 | swivel axis |
| 18 | vibration sensor | X | infeed direction |
| 19 | position sensor | Y | shift direction |
| 20 | workpiece carrier | Z | feed direction |
| 21 | workpiece spindle | b1, b2 | single contact track width |
| 211 | workpiece spindle drive | b_{eff} | effective contact track width |
| 212 | workpiece vibration module | S | contact track spacing |
| 23 | workpiece | d | Depth of penetration |
| 30 | dressing device | r | radial coordinate |
| 31 | swivel device | φ | angular coordinate |
| 32 | dressing spindle | | |
| 33 | dressing tool | | |

1. A method for producing a modified surface structure on a tooth flank of a pre-toothed workpiece,
the method comprising:
driving a grinding worm to rotate about a worm axis;
driving the pre-toothed workpiece to rotate about a workpiece axis, wherein the grinding worm and the pre-toothed workpiece are in rolling engagement;
generating a relative movement between the grinding worm and the pre-toothed workpiece, the relative movement having an axial component parallel to the workpiece axis, such that a plurality of adjacent contact tracks is produced on the tooth flank of the pre-toothed workpiece, the contact tracks extending at a distance from one another with respect to a workpiece face width direction,
characterized in that the method further comprises:
deliberately varying a penetration depth between the grinding worm and the pre-toothed workpiece along the respective contact track to generate a tooth flank waviness with a plurality of wave periods along said contact track, such that the tooth flank waviness of adjacent contact tracks at any given position in a workpiece depth direction are shifted relative to one another by a phase offset,
wherein the phase offset fulfills at least one of the following conditions:
a) the phase offset is between 90° and 270°,
b) the phase offset to the respective adjacent contact tracks varies from contact track to contact track,
c) the phase offset to the adjacent contact tracks varies along the respective contact track.

2. The method of claim 1, wherein the grinding worm rotates at a worm rotational frequency and wherein the deliberate variation of the penetration depth takes place at a variation frequency which is greater than the worm rotational frequency.

3. The method of claim 1, wherein the deliberate variation of the penetration depth comprises:
generating a deliberate relative additional movement between the pre-toothed workpiece and the grinding worm.

4. The method of claim 3, wherein generating the deliberate relative additional movement comprises at least one of the following:
a) exciting a translational vibration of the grinding worm with a vibration component in an infeed direction radial to the workpiece axis,
b) exciting a translational vibration of the grinding worm with a vibration component parallel to the workpiece axis,
c) exciting a translational vibration of the grinding worm with a vibration component in a shift direction parallel to the worm axis,
d) exciting a torsional vibration of the grinding worm about the worm axis.

5. The method of claim 3, wherein the pre-toothed workpiece is arranged on a workpiece spindle and wherein generating the deliberate relative additional movement comprises at least one of the following:
a) exciting a torsional vibration of the workpiece spindle about the workpiece axis,
b) exciting a bending vibration of the workpiece spindle,
c) exciting a translational vibration of the workpiece spindle.

6. The method of claim 1, wherein the grinding worm has a thread waviness on a grinding worm thread flank of a grinding worm thread, and wherein deliberately varying the penetration depth to produce the gear flank waviness comprises:
transferring the thread waviness of the grinding worm thread flank to the tooth flank of the pre-toothed workpiece that is in rolling engagement with the grinding worm.

7. The method of claim 6, further comprising:
dressing the grinding worm with a dressing tool, wherein the dressing tool exhibits at least one of the following features:
a) the dressing tool exhibits radial runout and a fixed or variable rotational angle ratio between the dressing tool and the grinding worm is predetermined such that the radial runout produces the thread waviness on the grinding worm thread flank;
b) the dressing tool exhibits axial runout and a fixed or variable rotational angle ratio between the dressing tool and the grinding worm is predetermined such that the axial runout produces the thread waviness on the grinding worm thread flank.

8. The method of claim 6,
wherein the grinding worm has at least two grinding worm threads,
wherein each of the at least two grinding worm threads has a respective thread waviness along a worm contact path, and
wherein the at least two grinding worm threads each produce adjacent contact tracks on the tooth flank, each contact track on the tooth flank being associated with one of the at least two worm contact paths.

9. The method of claim 8, wherein the worm contact paths each have a worm contact path starting point which is associated with a contact track starting point of the respective contact track on the tooth flank, wherein the thread waviness of the at least two grinding worm threads at the respective worm contact path starting point are out of phase with each other.

10. The method of claim 8, wherein the thread waviness of the at least two grinding worm threads have a difference in wavelength.

11. The method of claim 8, wherein the thread waviness of the at least two grinding worm threads have a difference in waviness amplitude.

12. The method of claim 1
wherein the grinding worm has at least two grinding worm threads, the method further comprising:
dressing one of the grinding worm threads of the grinding worm with a constant axial pitch error to produce a protruding grinding worm thread, the axial pitch error being chosen such that the protruding grinding worm thread achieves a greater penetration depth than its preceding and succeeding grinding worm threads with respect to a meshing sequence on the tooth flank, such that the protruding grinding worm thread at least partially grinds over the contact tacks produced by its preceding grinding worm threads.

13. The method of claim 1,
wherein the deliberate variation of the penetration depth is superimposed with uncontrolled deviations of the penetration depth, and wherein the deliberate variation of the penetration depth is carried out with a modulation amplitude which lies in a range between 0.2 times and 5 times a fluctuation measure for the uncontrolled deviations of the penetration depth.

14. A machine tool, comprising:
a tool spindle which is configured to receive a grinding worm for rotation about a worm axis;
a workpiece spindle which is configured to receive a pre-toothed workpiece for rotation about a workpiece axis;
an axial slide with an axial drive for generating a relative movement between the tool spindle and the workpiece spindle, the relative movement having an axial component parallel to the workpiece axis, and
a controller configured to perform the method of claim 1.

15. The machine tool of claim 14, comprising a shift slide with a shift drive for generating a displacement of the grinding worm in a shift direction parallel to the worm axis, wherein at least one of the following conditions is fulfilled:
a) the shift drive is configured to excite a translational vibration of the shift slide in the shift direction,
b) the axial drive is configured to excite a translational vibration of the axial slide with a vibration component parallel to the workpiece axis,
c) the tool spindle is configured to excite a torsional vibration of the grinding worm about the worm axis,
d) the machine tool has a tool carrier with a tool carrier drive for generating an infeed movement of the grinding worm in an infeed direction radial to the workpiece axis, wherein the tool carrier drive is configured to excite a translational vibration of the grinding worm in the infeed direction.

16. The machine tool of claim 14,
comprising a workpiece spindle drive for driving the workpiece spindle, wherein at least one of the following conditions is fulfilled:
a) the workpiece spindle drive is configured to excite at least one of the following:
a1) a torsional vibration,
a2) a bending vibration,
a3) a translational vibration of the workpiece spindle;
b) the machine tool has at least one separate workpiece vibration module which is configured to excite at least one of the following:
b1) a torsional vibration,
b2) a bending vibration,
b3) a translational vibration of the workpiece spindle.

17. The method of claim 8, wherein the thread waviness generated on the respective grinding worm threads along the worm contact paths differ from each other.

18. The method of claim 13, wherein the uncontrolled deviations of the penetration depth are stochastically occurring, and
wherein the fluctuation measure corresponds to a standard deviation or an interquartile range of the uncontrolled deviations of the penetration depth.

19. The method of claim 13, wherein the fluctuation measure of the uncontrolled deviations of the penetration depth is determined and the modulation amplitude is specifically chosen as a function of the determined fluctuation measure.

20. The machine tool of claim 14, wherein the machine tool has at least one separate tool vibration module which is configured to excite at least one of the following:
a) a translational vibration in the shift direction of at least one of
a1) the shift slide,
a2) the tool spindle;
b) a translational vibration of the axial slide with a vibration component parallel to the workpiece axis,
c) a translational vibration of the tool carrier in the infeed direction,
d) a torsional vibration of the tool spindle about the worm axis.
